(19) United States
(12) Patent Application Publication
(10) Pub. No.: US 2024/0025647 A1
(43) Pub. Date: Jan. 25, 2024

(54) Automated Inventory Management And Delivery System For Climate-Controlled Environments

(71) Applicant: RIOS Intelligent Machines, Inc., Menlo Park, CA (US)

(72) Inventors: Christopher A. Paulson, Belmont, CA (US); Michael A. Benedict, San Mateo, CA (US); Christopher Lalau Keraly, San Francisco, CA (US)

(73) Assignee: RIOS Intelligent Machines, Inc., Menlo Park, CA (US)

(21) Appl. No.: 18/225,637

(22) Filed: Jul. 24, 2023

Related U.S. Application Data
(60) Provisional application No. 63/369,195, filed on Jul. 22, 2022.

(51) Int. Cl. B65G 1/137; G06Q 10/087; B25J 9/16; B65G 1/04

(52) U.S. Cl. CPC B65G 1/1376; G06Q 10/087; B25J 9/1687; B65G 1/0407

(57) ABSTRACT

An Inventory Management and Delivery System (IMDS system) manages product items within a climate-controlled enclosure (e.g., beverage case) in an automated manner using a product loading (ingestion) subsystem to convey product items into the enclosure's climate-controlled environment and utilizes two gantry robots and an articulated robot to perform all backstocking/storage and delivery/restocking operations. Product items are ingested on standardized crates to simplify backstocking/retrieval of various product types from an array of storage locations using the first (backstocking) gantry robot. During restocking operations, the required crates are retrieved from storage and individual items are extracted and by the articulated robot and transferred to the second (delivery) gantry robot. The second gantry robot utilizes a simplified channel-type delivery mechanism to deliver each product item to its associated display shelf location. An inventory control subsystem monitors the number of each product item type disposed within the climate-controlled enclosure to prevent lost sales.

### PRIORITY APPLICATION

The present application claims priority to U.S. Provisional Patent Application 62/369,195 entitled “183NM LASER AND INSPECTION SYSTEM”, filed by Paulson et al. on Jul. 22, 2022.

### FIELD OF THE INVENTION

This invention relates to automated vending systems, and more particularly to robotic systems and methods directed to managing product items in climate-controlled environments.

### BACKGROUND OF THE INVENTION

A beverage case represents one type of climate-controlled environment (refrigeration system) that is often used in retail businesses (e.g., convenience stores and grocery markets) to display cold beverages (e.g., soft drinks or juice in cans and bottles) for purchase by the business' retail customers. Such beverage cases often include multiple chute-type display shelves arranged in rows and columns, with each chute-type display shelf including beverages that are slidably disposed and gravity-fed toward a display (front) wall of the case. To improve sales, the various beverage brands and types are typically arranged according to a computer-generated planogram such that more popular beverages are presented on display shelves located at an average customer's eye level, and less popular beverages are disposed on lower or higher display shelves. The forward-most beverages disposed in the multiple chute-type display shelves are arranged in a vertical plane located immediately behind multiple glass access doors that collectively form a front wall of the beverage case. This arrangement minimizes power consumption by allowing a customer to identify a selected beverage while all access doors are closed, then remove the selected beverage from the beverage case by manually opening only the glass access door located in front of the selected beverage. This arrangement also automatically re-faces the beverage display because, when a beverage is removed from its associated display shelf, an identical beverage disposed immediately behind the selected/removed beverage slides forward on the chute-type display shelf, thereby maintaining a fully faced beverage display for subsequent customers.

To prevent lost sales due to empty display shelves, beverage cases must be managed such that resupply (replacement) beverages are added to the display shelves at a rate that keeps pace with customer purchases. Beverage case management generally involves determining an average rate of sale of each beverage type and using this average rate data to prevent depletion (running out) of on-hand inventory between periodic resupply deliveries from distributors or other sources. In the case of more popular beverages, it is sometimes necessary to order more beverage units than the total number that can be loaded onto the assigned display shelves. For example, if each display shelf holds ten beverage units, a given planogram assigns one display shelf for a particular beverage, and the average rate of sale between periodic deliveries of the particular beverage is twenty units, then twenty units may be ordered for each delivery, with the extra beverage units (i.e., those not loaded on the assigned display shelf) being store as backstock inventory disposed behind the display shelves in the beverage case. This arrangement requires periodic restocking of the display shelves, which typically involves manually moving beverage containers from a backstock locations onto assigned display shelves. This manual restocking process is typically performed by delivery personnel (e.g., a beverage distributor) and/or by the retail business owner/employees.

Current beverage case management approaches present several inefficiencies and other problems that result in increased operating costs and/or lost sales. First, the reliance on employees (human service personnel) to perform manually restocking tasks the beverage case results in relatively high energy costs due to the loss of cold air caused by employees entering/exiting and working within the beverage case, and also can result in stocking beverage containers on incorrect display shelves (i.e., in violation of an established planogram). Second, due to ever increasing cost of training and maintaining large work forces, retail business owners are looking for ways to automate repetitive tasks (such as restocking beverage cases) to allow a smaller number of employees to focus on more profitable tasks, such as customer support. Third, the reliance on employees to perform inventory tasks inevitably produces human-error-related issues, such as a failure to notice the increased popularity of a particular beverage type that results in empty display shelves and lost sales.

What is needed is an automated management system for climate-controlled environments (e.g., beverage cases) that avoids the problems and inefficiencies produced by conventional management approaches.

### SUMMARY OF THE INVENTION

The present invention is directed to an Inventory Management and Delivery System (IMDS system) that manages product (e.g., beverage) items within a climate-controlled enclosure (e.g., a beverage case) in an automated manner that addresses the problems associated with conventional manual approaches using some or all of the various subsystems described herein. For example, in some embodiments the IMDS system utilizes a product loading subsystem configured to automatically ingest (receive deliver of) product items into the enclosure's climate-controlled environment by way of a relatively small loading port, thereby reducing energy costs over conventional (manual) restocking approaches. Second, in some embodiments the IMDS system utilizes a coordinated series of robot-based subsystems disposed within the climate-controlled environment to automatically perform backstock (storage) and display (restocking) operations by moving each product item type from its designated storage location to a specific display shelf location according to a preset planogram, thereby further reducing energy costs and also reducing labor costs over conventional manual approaches. Third, the IMDS system utilizes an inventory control subsystem that is configured to keep track of the number of each product item type disposed within the climate-controlled enclosure in a way that reduces the occurrence of empty display shelves and associated lost sales over human-based inventory methods. When all of these subsystems are utilized, the IMDS system is capable of managing product items within a climate-controlled enclosure in an automated manner that addresses the above-mentioned problems associated with conventional manual approaches.

In an exemplary embodiment, the IMDS system is utilized to manage cold beverage-type product items (e.g., cans and/or bottles containing soda or other consumable fluids) within a beverage case (climate-controlled enclosure) disposed in a retail establishment (e.g., a convenience store). Like most standard beverage cases, the beverage case associated with IMDS system includes a peripheral insulated wall surrounding an enclosed climate-controlled environment (cold storage region) and utilizes a refrigeration unit to maintain the cold storage region at a desired temperature. In some embodiments, a front (display) wall section of the peripheral wall faces into a customer accessible region of the retail establishment and includes transparent product access doors that allow customers to view and remove beverage items from planogram-assigned chute-like display shelf locations located just inside the product access doors. Backstocked beverage items are arranged in backstock storage locations disposed along a back wall section (i.e., opposite to the front wall section) such that a service access region (gap) is provided between the backstock storage and display shelves to facilitate manual display shelf restocking operations. The beverage case differs from at least some standard beverage cases in that it includes a relatively small loading port configured to facilitate the ingestion of newly delivered beverage items (i.e., beverage items delivered to the retail establishment, for example, by a product distributor/supplier, to replenish beverage items removed from the beverage case by customers). In some embodiments the IMDS system may be retrofitted to the beverage case, and in other embodiments the beverage case may be integrated into (i.e., a part of) the IMDS system.

In presently preferred embodiments, beverage items are ingested into the beverage case in batches by way of crates (totes). Each crate is an opened-top box-like storage unit having an array of storage spaces that are configured to collectively contain/carry an associated batch of beverage items (i.e., with one beverage item disposed in each storage space). In some embodiments, the beverage items are also packaged, transported and delivered to the retail establishment in associated crates. In an embodiment, the crates are configured such that one crate (i.e., one batch of beverage items) is passed through the loading port into beverage case during each ingestion operation. As explained in additional detail below, each batch of beverage items remains in its associated crate during backstocking (storage) operations (i.e., each crate is disposed in a computer-assigned backstock storage locations) and is removed from its associated crate during delivery (display shelf restocking) operations, thereby greatly simplifying the automated ingestion, backstocking (storage) and transfer operations performed by the IMDS system. In one embodiment, the crates utilized in accordance with the IMDS system have a standardized footprint (e.g., all crates have the same exterior wall dimensions), but the interior divider configuration may be varied to efficiently accommodate a range of beverage item container types and sizes (e.g., single- or multi-serving bottles, various can sizes, etc.). The use of crates having one or more standardized footprints further simplifies the storage and transfer operations (described below) by facilitating the use of relatively simple and reliable extraction mechanisms to deposit and retrieve stored beverage items, thereby reducing operating costs. Although the use of crates/totes greatly simplifies the ingestion, loading and transfer operations, similar operations may be performed using other containment devices (e.g., bags) to collectively move batches of product items.

In some embodiments a product loading subsystem is configured to automatically convey batches of beverage (product) items disposed on corresponding crates from a loading position located outside the climate-controlled environment to a receiving position located inside the climate-controlled environment. In an embodiment, the product loading subsystem includes a conveying mechanism that extends through a loading port (opening) in the rear or one of the side peripheral walls of the beverage case, an insulated product loading gate is operably disposed adjacent to the loading port and movable (e.g., by way of an appropriate actuator) between a closed state and an opened state, and an ingestion controller that is configured to coordinate operations of the conveying mechanism and the product loading gate during each product ingestion operation. In an exemplary embodiment, when one or more crates containing product items are placed on the conveying mechanism in the loading position, the ingestion controller transmits first control signals that actuate the product loading gate (i.e., such that the product loading gate moves from the closed state to the opened state), then transmits second control signals that actuate the conveying mechanism such that the product items are conveyed through the loading port to the receiving position, and then transmits third control signals that cause the product loading gate to move from the opened state to the closed state. In some embodiments, the product loading subsystem includes a user interface device through which loaded product SKU data is entered for all product items ingested into the beverage case. In alternative embodiments, the interface device may be a keyboard/keypad through which the SKU data is manually entered or may be a scanner or other automated input device that senses (reads) identifying information (e.g., barcode information printed on the ingested product items). In any case, the user interface device facilitates accurate management of the product items ingested into the beverage case by transmitting the loaded product SKU data to the inventory control subsystem, which utilizes the SKU data as described below. In some embodiments a safety device (e.g., a light curtain) is operably configured to delay all ingestion operations until the safety device verifies that a human arm (or other body part) is located over the loading position. In some embodiments, the IMDS system may utilize a manual insertion process in which crates are manually passed through the loading port to the receiving position.

In some embodiments the IMDS utilizes a backstock management subsystem to perform backstocking operations, where each backstocking operation involves transferring a newly delivered crate/batch from the receiving location to an assigned storage (backstock) location. The backstock management subsystem utilizes a first robotic system to perform the backstocking operations, where the robotic system is configured to remove a crate from the receiving position, move the crate to the assigned storage location on the backstock shelving, and place the crate on the assigned storage location. In a preferred embodiment, the first robotic system is a vertically oriented gantry robot system (aka, cartesian robot or linear robot) having a positioning mechanism configured to position an end effector in a vertical working plane in front of a vertically oriented array of backstock shelf locations, where the end effector includes an extraction mechanism capable of extracting (pulling) a selected crate from the receiving position onto a support structure/platform at the beginning of each backstocking operation, and capable of repositioning (pushing) the selected crate from the support structure/platform onto the assigned storage location during each backstocking operation. By utilizing the backstock management system to perform automated backstocking operations in this manner, the IMDS system avoids the need for deliver or store personnel to enter the beverage case, thereby significantly reducing operating (energy) costs by minimizing the escape of cold air from the beverage case. As set forth below, the backstock management subsystem also utilizes the first robotic system to retrieve a selected crate/batch from its assigned backstock location and move the selected crate/batch to a first transfer location at the beginning of each delivery (display shelf restocking) operation. That is, the IMDS system utilizes the backstocking management subsystem to perform both backstocking operations (i.e., after each new product ingestion operation), and to perform a first portion of each delivery operation during time periods in which ingestion operations are not being performed, thereby minimizing the number and complexity of the mechanisms required to automatically perform the two operations, thus minimizing overall system operating costs.

In an embodiment, the IMDS system utilizes a coordinated series of robot-based subsystems (i.e., the backstock management subsystem, a product handling subsystem and a display management subsystem that are coordinated by a central controller) to perform automated delivery (display shelf stocking/restocking) operations in accordance with user-supplied planogram data. The user-supplied planogram data specifies an arrangement of the beverage items on display shelfs in the beverage case such that each beverage type is positioned/displayed at a corresponding display location of display shelf, where the corresponding display location for each beverage item type is designated (assigned) by the planogram data. In addition to having access to the planogram data, the controller has access to inventory data including the number of beverage units and assigned backstock (storage) location for each beverage type. At the beginning of each delivery (display shelf stocking) operation, the controller transmits appropriate control signals to the backstock management subsystem that identify a selected type of beverage units to be retrieved (by way of their crate) from their assigned backstock (storage) location. As mentioned above, the backstock management subsystem utilizes a first robotic system to retrieve the selected crate/batch from its assigned backstock location and to move the selected crate/batch to a first transfer location. During a second portion of each delivery operation, the controller transmits appropriate control signals to the product handling subsystem, which utilizes a second robotic system to sequentially transfer the selected beverage items from the selected crate/batch, which is positioned at the first transfer location, to a second transfer location. During a second portion of each delivery operation, the controller also transmits appropriate control signals to the display management subsystem such that the display management subsystem is operably configured to receive the transferred beverage items at the second transfer location During a third portion of each delivery operation, the display management subsystem utilizes a third robotic system to move the transferred product items to a designated display shelf location.

In one embodiment, the IMDS system utilizes a first gantry robot mechanism to implement operations performed by the backstock management subsystem, an articulated robot mechanism to implement operations performed by the product handling subsystem, and a second gantry robot mechanism to implement operations performed by the display management subsystem. For example, the two gantry robot mechanisms and the articulated robot mechanism perform the delivery (display shelf stocking) operations, where the first gantry robot mechanism is utilized to remove a selected crate from its storage location and to move the first crate to the first transfer location, the articulated robot mechanism is utilized to sequentially remove product items from the selected crate and to move the product items to a second transfer location, and the second gantry robot mechanism is utilized to receive the product items from the articulated robot mechanism at the second transfer location, to move the product items from the second transfer location to a designated display location, and to sequentially place the product items on the designated display location. An advantage provided by this arrangement is that the two gantry robot mechanisms can be entirely disposed above the beverage case floor (e.g., fixedly attached to the shelf support frames that support the storage and display shelving units), which is desirable for safety and beverage case cleaning purposes. Another advantage provided by this arrangement is that the articulated robot mechanism can be positioned against a distal wall of the beverage case (i.e., opposite to the beverage case's service access door), thereby providing an unimpeded service access region between the storage shelves and the display shelves that can be used by store personnel to perform manual restocking operations, for example, when one or more of the robot-based subsystems is deactivated for maintenance or repair.

In a presently preferred embodiment, a method for automatically restocking a display shelf (i.e., moving a product item from its backstock storage location to a designated display (shelf) location within a climate-controlled enclosure includes: utilizing a first gantry robot mechanism to remove (retrieve) a crate containing the product item from the storage location and to move the first crate to a first transfer location, utilizing an articulated robot mechanism to remove the product item from the crate and to move the product item to a second transfer location, and utilizing a second gantry robot mechanism to receive the product item from the articulated robot mechanism at the second transfer location, to move the product item from the second transfer location to the designated display location, and to place the product item on the first display location. Utilizing two gantry robot mechanisms to perform the crate retrieval and product delivery operations facilitates easy modification and adaptation to a wide variety of storage shelf and display location settings, thereby significantly increasing system reliability and decreasing operating costs. Moreover, utilizing an articulated robot to transfer product items between the two gantry robots greatly simplifies the required end effector operations of the two gantry robots.

In some embodiments, an IMDS system utilizes one or more image-based or sensor-based displayed-product monitoring systems to identify and/or monitor the number of each product item type disposed on their designated display locations in order to detect the incremental removal of each product item from the climate-controlled environment. In some embodiments the displayed-product monitoring system is configured to communicate with the central controller by way of wired or wireless digital communications to facilitate updated inventory information regarding the number of displayed product items, and the central controller initiates restocking operations when the number of product items at a given display locations falls below a predetermined minimum value.

### BRIEF DESCRIPTION OF THE DRAWINGS

These and other features, aspects and advantages of the present invention will become better understood with regard to the following description, appended claims, and accompanying drawings, where:

FIG. 1 is a diagram depicting an IMDS system according to an exemplary embodiment;

FIGS. 2A, 2B and 2C are simplified perspective views depicting an exemplary ingestion operation performed by a product loading subsystem of the IMDS system of FIG. 1;

FIGS. 3A, 3B, 3C, 3D and 3E are simplified perspective views depicting operations performed by a backstock management subsystem of the IMDS system of FIG. 1;

FIGS. 4A and 4B are simplified perspective views depicting a product transfer operation performed by a product handling subsystem of the IMDS system of FIG. 1;

FIGS. 5A and 5B are simplified perspective views depicting a display management subsystem of the IMDS system of FIG. 1;

FIGS. 6A, 6B, 6C and 6D are simplified side views showing a product delivery (restocking) operation performed by the display management subsystem of FIG. 5A;

FIG. 7 is a simplified diagram depicting an IMDS system according to a second exemplary embodiment;

FIG. 8 is a simplified perspective view depicting a modified backstock management subsystem according to another exemplary embodiment; and

FIGS. 9A, 9B, 9C, 9D and 9E are simplified top views depicting a product sorting operation performed by the modified backstock management subsystem according to another embodiment; and

FIG. 10 is a perspective view depicting an IMDS system according to another exemplary embodiment.

### DETAILED DESCRIPTION OF THE DRAWINGS

The present invention relates to an improvement in methods and apparatus/systems for managing product items stored in climate-controlled environments. The following description is presented to enable one of ordinary skill in the art to make and use the invention as provided in the context of a particular application and its requirements. As used herein, directional terms such as “front”, “rear”, “back”, “vertical” and “horizontal” are intended to provide relative directions and positions for purposes of description and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described but is to be accorded the widest scope consistent with the principles and novel features herein disclosed.

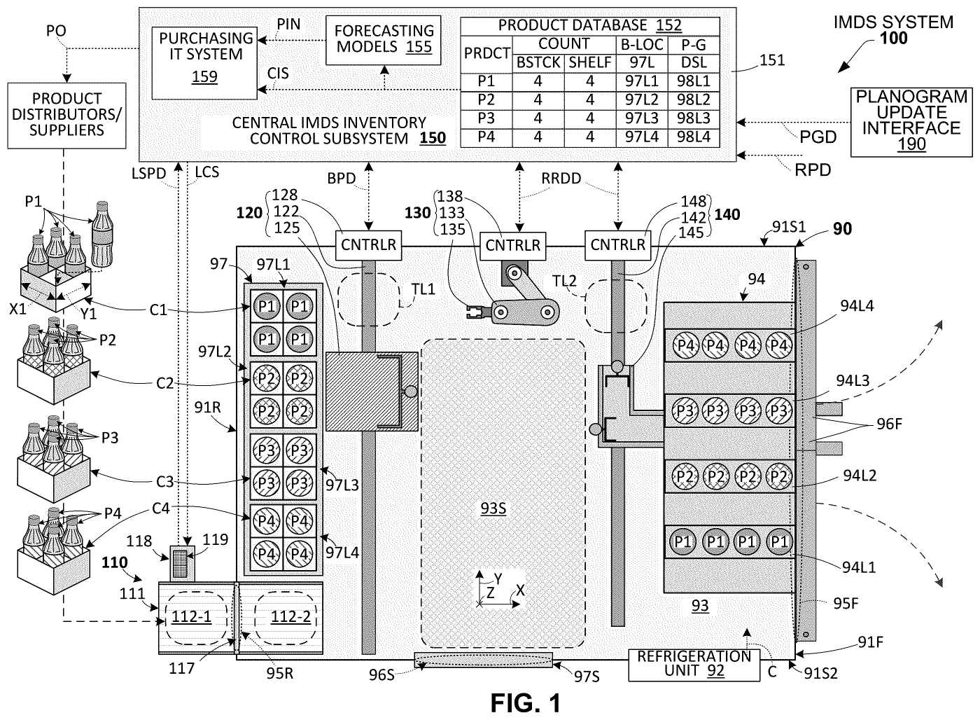

FIG. 1 shows an exemplary automated Inventory Management and Delivery System (IMDS system) 100 that is configured to automatically manage beverage items (product items) P1 to P4 within a beverage case (climate-controlled environment) 90 in accordance with user-supplied planogram data PGD. Reference numbers P1 to P4 are utilized to identify four different beverage types (e.g., where beverage items P1 are cola-flavored soda, beverage items P2 are root beer soda, etc.). Beverage items P1-P4 are depicted as bottled beverages of a single size for brevity and clarity. Although the management operations performed by IMDS system 100 are described below with reference to a relatively small number of beverage items (i.e., beverage items P1 to P4) that are dispensed in a single bottle type/size, those skilled in the art will recognize that the described operations may be extended to manage a much larger number of beverage types and container types/sizes. The user-supplied planogram data PGD, which may be received electronically from a planogram update interface 190 (e.g., a personal computer or other device), specifies the arrangement of beverage items P1 to P4 on a display shelf 94 disposed inside beverage case 90 (e.g., beverage items P1 are to be arranged at designated (assigned) display location 94L1 on display shelf 94, beverage items P2 are to be arranged at designated display location 94L2, beverage items P3 are to be arranged at designated display location 94L3, and beverage items P4 are to be arranged at designated display location 94L4).

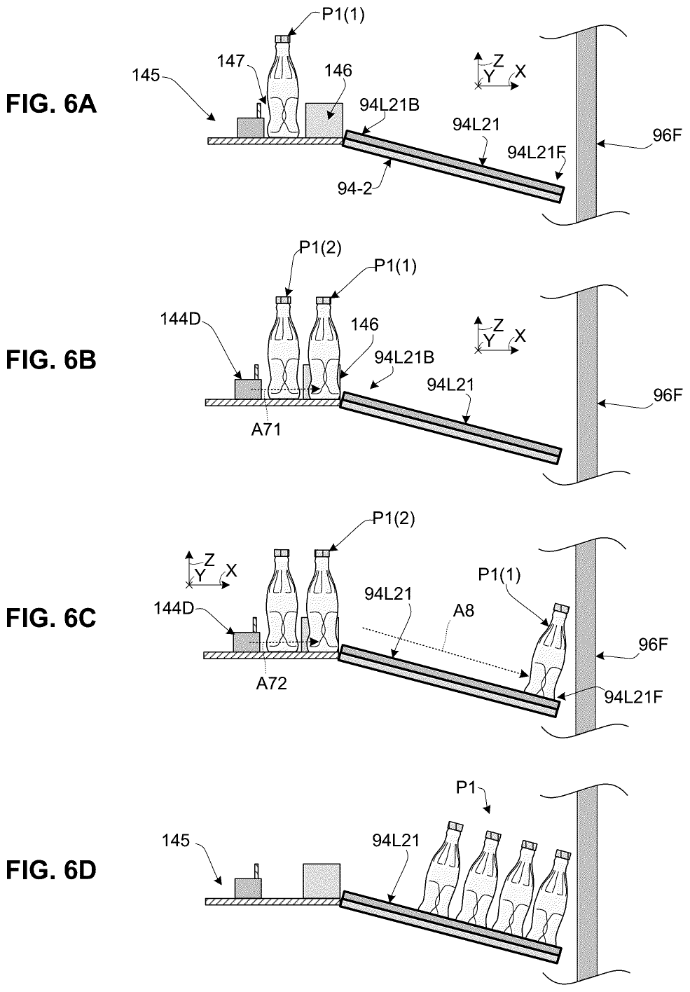

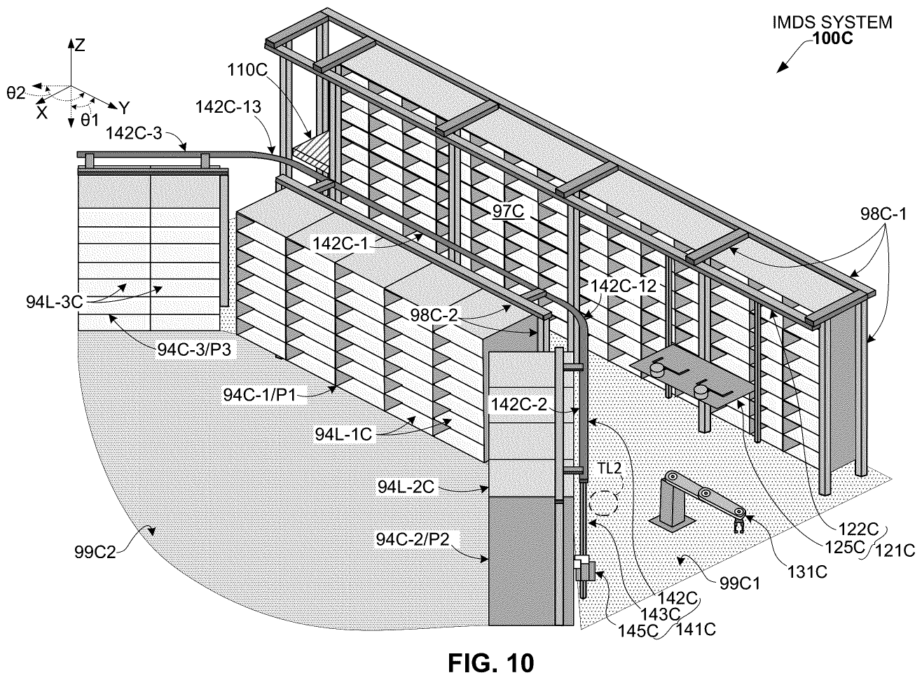

Beverage case 90 includes a peripheral insulated wall 91 surrounding an enclosed climate-controlled environment (cold storage region) 93 and utilizes a standard walk-in (e.g., self-contained, remote condensing, or multiplex condensing) refrigeration unit 92 that is configured to generate and supply cold air C (e.g., 40° F.) into the cold storage region 93. In the exemplary embodiment, peripheral wall 91 forms a four-sided structure including a front (first) wall section 91F, an opposing rear (second) wall section 91R, and opposing side-wall sections 91S1 and 91S2 that extend between front wall section 91F and rear wall section 91R such that peripheral wall 91 surrounds a refrigerated region (climate-controlled environment) 93. Display shelf 94 and backstock shelf 97 are contained within refrigerated region 93, with display shelf 94 including multiple chute-type display shelf locations 94L1 to 94L4 arranged along a front wall section 91F, and with backstock shelf 97 including multiple storage (backstock shelf) locations 97L1 to 97L4 arranged along rear wall section 91R. Front wall section 91F faces into a retail space (customer accessible region) of the retail establishment, and rear wall section 91R and at least a portion of the two side wall sections 91S1 and 92S2 are disposed in a service space (i.e., a region typically not intended for customer access). One or more product access doors 96F (e.g., glass or another light transparent material surrounded by a hinged metal frame) are mounted over a relatively large front opening 95F defined in front wall section 91F. With this arrangement, customers visiting the retail space are able to view the various beverage item types P1 to P4 through product access doors 96F, then manually open product access doors 96F and manually remove selected beverage items (e.g., beverage item P1) from their designated display shelf locations 94L1 to 94L4. Each display shelf location 94L1 to 94L4 is configured to align beverage items perpendicular to front wall section 111F and have a chute-type configuration (described below, for example, with reference to FIGS. 6A to 6D) that gravity-feeds the beverage items P1 to P4 toward product access door 96F, whereby removal of the front-most beverage item from each display shelf location causes any remaining beverage items to slide forward (toward the access door 96F). Display shelf 94 and backstock shelf 97 are sufficiently spaced such that they are separated by a service access region 93S of sufficient width to allow a human to perform manual restocking operations while standing in service access region 93S. In alternative embodiments (e.g., such as that shown in FIG. 10), the beverage case may include more than four wall sections, provided that a suitable gap exists between the display and backstock shelving.

Referring to the lower left portion of FIG. 1, in the exemplary embodiment batches of beverage items P1 to P4 are delivered, ingested and stored inside beverage case 90 using associated crates (totes) C1 to C4 in order to simplify the ingestion and storage operations. Each crate C1 to C4 is a box-like storage unit having a bottom wall (not shown) and a peripheral side wall that surrounds an array of storage spaces separated by intervening interior dividers (e.g., wall sections). In the simplified example shown in FIG. 1, each crate C1 to C4 is configured to accommodate four bottle-type beverage items, where crate C1 is configured with four storage spaces and used to transport a batch of four beverage items of type P1 (cola). Similarly, crate C2 is configured to contain a batch of four beverage items of type P2 (e.g., root beer), crate C3 contains a batch of four beverage items of type P3 (e.g., lemon-lime soda), and crate C4 contains a batch of four beverage items of type P4 (e.g., orange soda). As indicated by crate C1, a single beverage item P1 is placed in each of the four storage spaces such that a lower portion of each of the four beverage items P1 is supported by the bottom wall (not shown) of crate C1 and the upper portions of beverage items P1 are exposed (i.e., such that each beverage item P1 can be removed from crate C1 by way of grasping its upper portion and pulling/lifting away from crate C1). In one embodiment, all crates ingested and stored by system 100 have the same or similar footprint (i.e., each of crates C1 to C4 has the same exterior wall dimensions X1 and Y1 that are indicated on crate C1). As indicated in plan view inside beverage case 90, in one embodiment the uniform footprint of crates C1 to C4 is optimized to facilitate efficient storage within and removal from backstock storage locations 97L1 to 97L4, respectively. In some embodiments (not shown), the interior divider configuration of some crates may differ from that depicted in FIG. 1 to efficiently accommodate a range of beverage item container types and sizes. That is, although each of crates C1 to C4 is indicated as having four storage spaces to accommodate beverage items of the same size, other crates may include only one storage space (e.g., to accommodate a large multi-serving bottle, can or other container type), or may include a larger number of storage spaces (e.g., nine, sixteen, etc.) to accommodate smaller bottles or can sizes). In some embodiments, crates C1 to C4 may be designed in a reconfigurable manner to be adjusted to different container dimensions. In some embodiments, empty crates are moved outside of climate-controlled environment (e.g., backward through loading port 95R) for reuse in order to accommodate a more efficient distribution and delivery to various endpoints.

In the exemplary embodiment, IMDS system 100 includes a product loading system 110, a backstock managing subsystem 120, a product handling subsystem 130, a display management subsystem 140, and a central IMDS inventory control subsystem (central controller) 150.

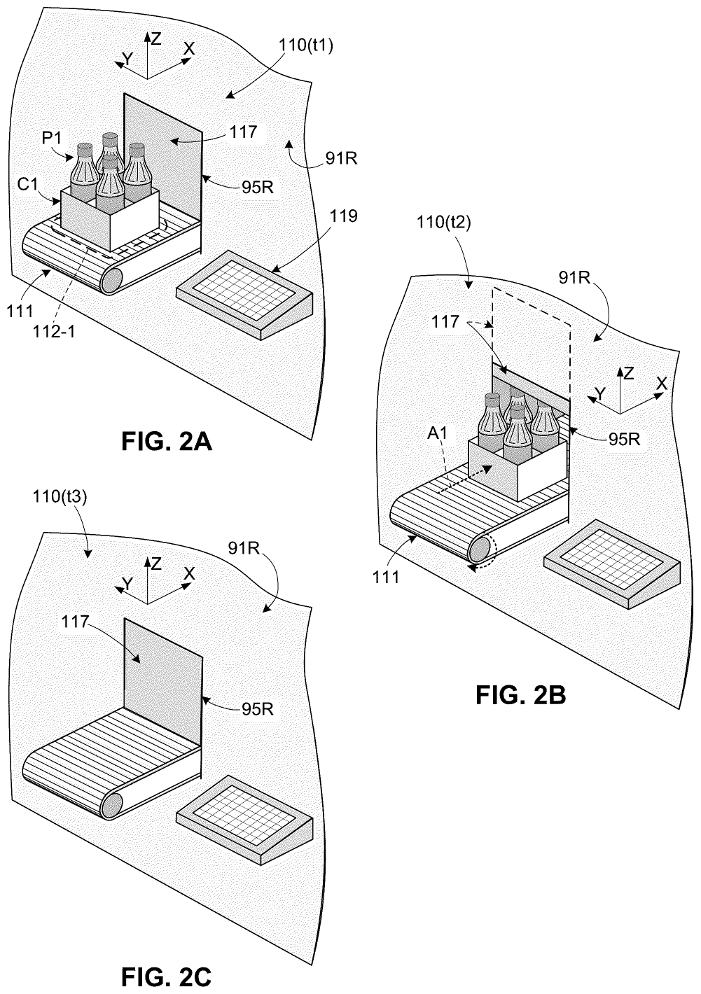

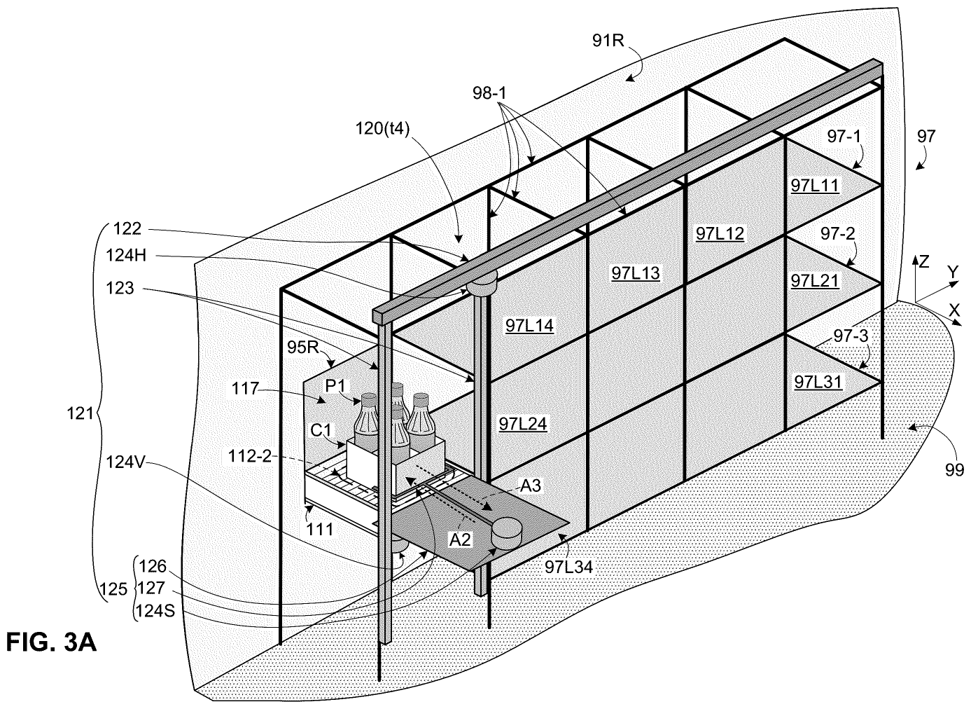

Referring to the lower left portion of beverage case 90 (FIG. 1), product loading subsystem 110 includes a conveying mechanism 111 that extends through loading port (opening) 95R in the rear or one of the side peripheral walls 91 of the beverage case 90, an insulated product loading gate 117 that is operably disposed adjacent to the loading port 95R, and an ingestion controller 118 that is configured to coordinate operations of the conveying mechanism 111 and the product loading gate 117 during each product ingestion operation. As described below with reference to FIGS. 2A to 2C, product loading ingestion subsystem 110 is configured such that, during each product ingestion operation, product loading gate 117 is automatically opened, a batch (e.g., one of crates C1 to C4) of product items that has been placed on conveying mechanism 111 at a loading position 112-1 (e.g., an upper conveyor belt section located outside beverage case 90) is automatically conveyed through loading port 95R to a receiving position 112-2 located inside climate-controlled environment 93, and then product loading gate 117 is automatically closed.

In some embodiments, product loading subsystem 110 includes a user interface device 119 through which loaded product SKU data is entered for all product items ingested into beverage case 90. In one embodiment, user interface device 119 may be a keyboard or keypad that may be connected to ingestion controller 118 and used by delivery or store personnel to manually enter SKU data identifying each batch of beverage items ingested during a given ingestion operation. For example, after a delivery person places crate C1 onto conveying mechanism 111 at loading position 112-1, the delivery person is tasked to enter a code or other information that operably identifies the batch of four beverage items of type P1 that are mounted on crate C1. In an alternative embodiment, user interface device 119 may include an infrared scanner or other input device that reads identifying information from crate C1 or from beverage items P1 before or during each associated ingestion operation. In another embodiment the beverage items ingested into beverage case 90 pass under an auto SKU recognition device (not shown) that scans each item and generates corresponding identification information. In any case, the entered/generated information is utilized to generate loaded product SKU data LSPD, which is transmitted as corresponding to central controller 150 (as indicated by the dashed-line arrow). As described in additional detail below, central controller 150 adjusts product database 152 to reflect the batch information provided with loaded product SKU data LSPD. In some embodiments, ingestion operations performed by product loading subsystem 110 are at least partially controlled by central controller 150 (e.g., by way of loading control signals LCS), for example, to prevent initiating a product ingestion operation until a previously ingested batch has been moved into an assigned backstock storage location.

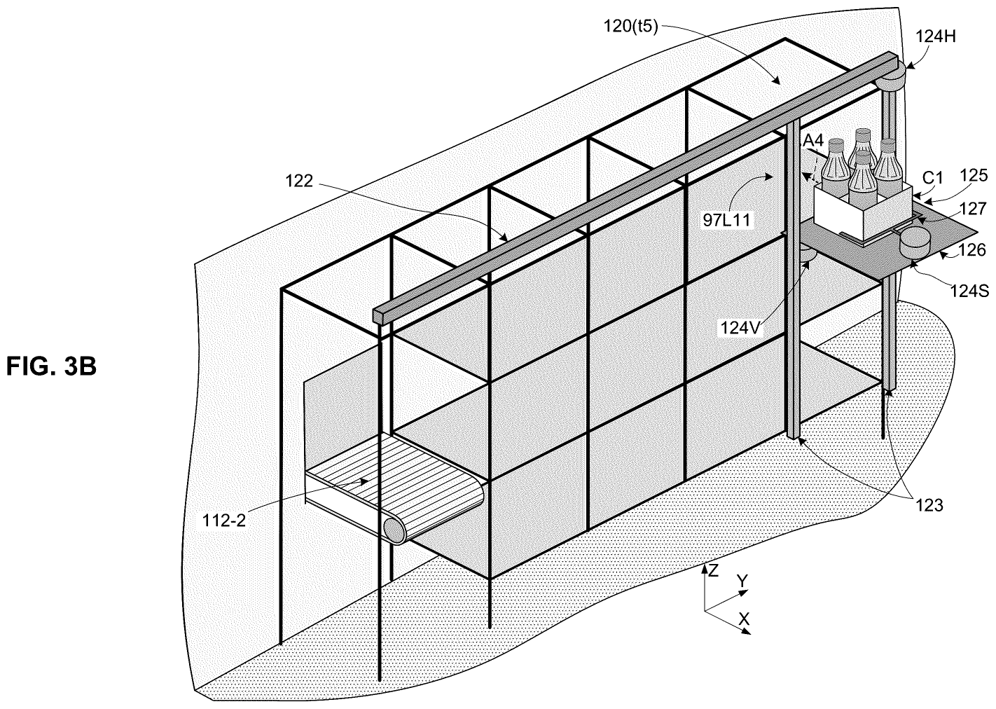

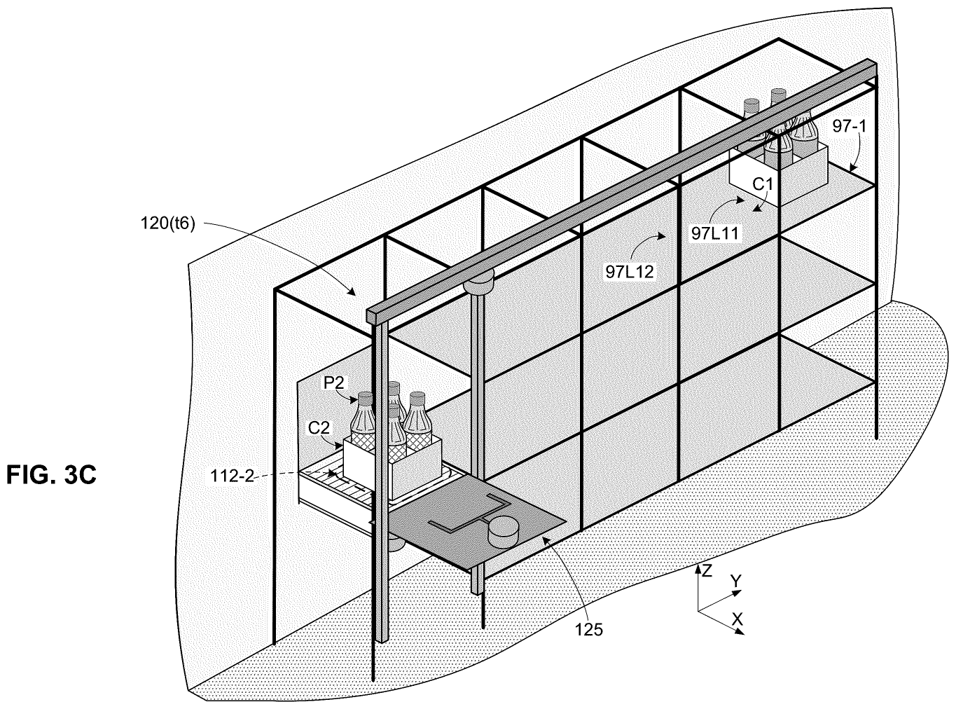

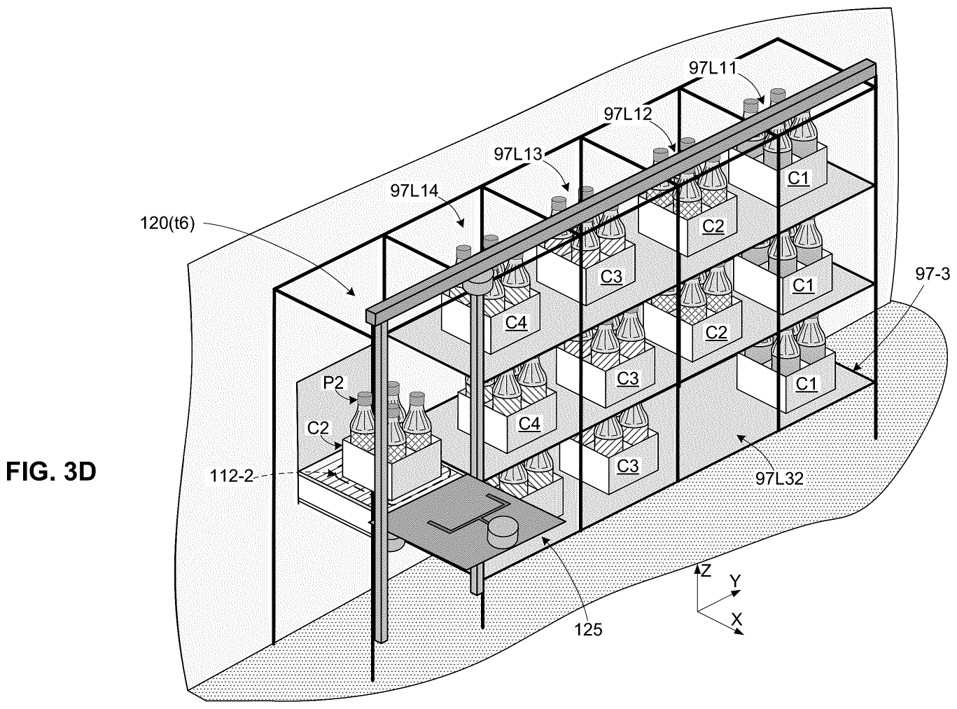

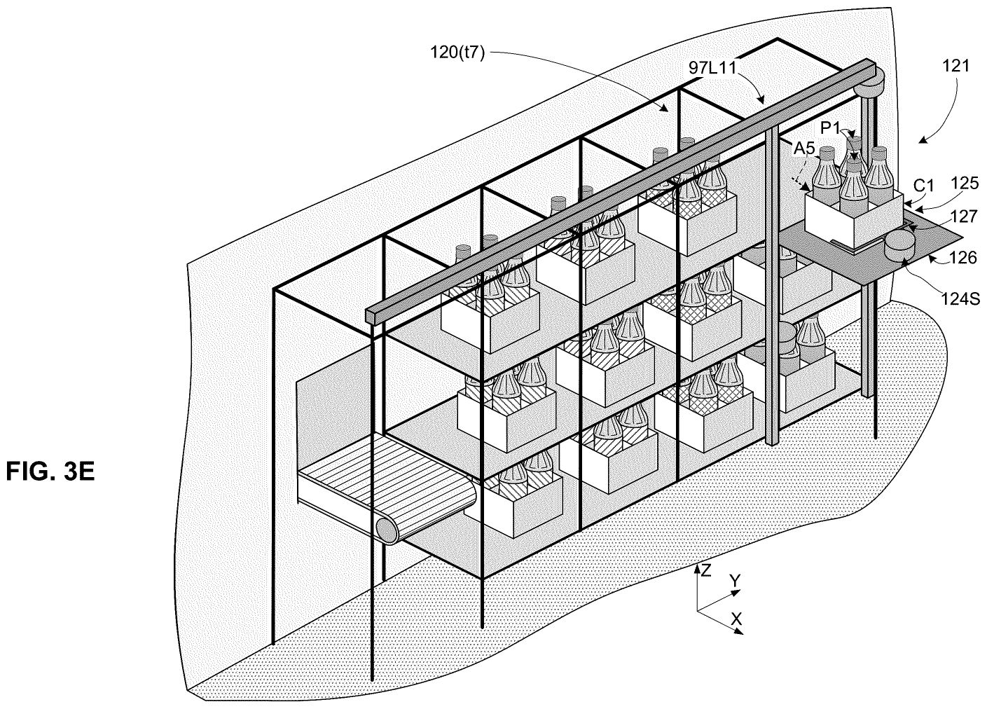

Referring to the right of storage shelf 97 in FIG. 1, backstock management subsystem 120 includes a first robotic system (represented in FIG. 1 by a horizontal rail 122 and an end effector 125 for brevity) that is controlled by an associated controller 128 to perform storage operations and a first portion of each deliver (display shelf stocking) operation. An exemplary storage operation is described in additional detail below with reference to FIGS. 3A to 3D, whereby, after a crate is ingested by product loading subsystem 110, end effector 125 is moved to a location adjacent to receiving position 112-2, then actuated to procure (grasp and move) the crate, then moved (with the crate) to an assigned storage location, and then actuated to deposit (push) the crate into the assigned storage location. The first portion of exemplary delivery operation is described in additional detail below with reference to FIG. 3E, whereby end effector 125 is moved to a location adjacent to a selected crate's storage location, then actuated to procure (grasp and withdraw) the selected crate from the storage location, then moved (with the selected crate) to a designated transfer location TL1.

As described in additional detail below, central controller 150 controls the operations performed by backstock management subsystem 120 by way of backstock product data BPD (as indicated by the dashed-line arrow). In one embodiment, after each ingestion operation central controller 150 assigns a backstock shelf location (B-LOC) to the ingested crate and then transmits control signals (by way of backstock product data BPD) that cause backstock management subsystem 120 to move the ingested crate to its assigned storage location (i.e., to perform an associated storage operation). Similarly, when the number of beverage items at a given display location reach a predetermined minimum number, central controller 150 identifies a crate/location containing the relevant beverage items, then transmits control signals (by way of backstock product data BPD) that cause backstock management subsystem 120 to retrieve the relevant crate from its assigned storage location and position the crate at transfer location TL1 (i.e., to perform the first portion of an associated delivery operation).

Referring to the central region of FIG. 1, product handling subsystem 130 includes a second robotic system that is configured (e.g., by way of an arm mechanism 133 and an appropriate end effector/gripper 135) to sequentially transfer product items from a crate to a second transfer location TL2 during a second portion of each delivery (display shelf stocking) operation (i.e., while the crate is maintained at first transfer location TL1 by backstock management subsystem 120). Product handling subsystem 130 also includes a controller 138 that communicates with central controller 150 by way of restock request/delivered data RRDD.

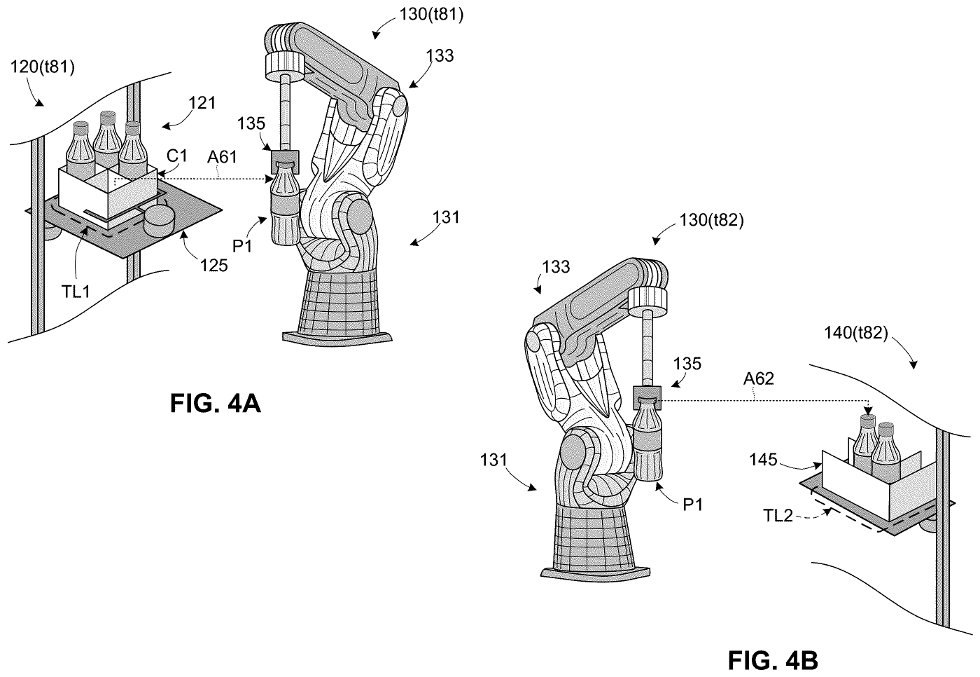

Referring to the left side of display shelf 94 in FIG. 1, display management subsystem 140 includes a third robotic system (represented in FIG. 1 by a horizontal rail 142 and an end effector 145 for brevity) that is controlled by an associated controller 148 to perform a third portion of each delivery (display shelf stocking) operation. An exemplary delivery operation is described in additional detail below with reference to FIGS. 4B, 5A and 6A to 6D, whereby end effector 145 is moved to second transfer location TL2 receive beverage items transferred from product handling subsystem 130, then moves the transferred beverage items to an assigned display location, and then actuated to sequentially deposit (push) the beverage items onto the assigned display location. Display management subsystem 140 is controlled by central controller 150 by way of restock request/delivered data RRDD.

Referring to the upper portion of FIG. 1, central controller 150 includes an electronic computing device 151 (e.g., a processor and associated digital memory) that is configured (e.g., by way of software algorithms) to control automatic loading/delivery operations performed within beverage case 90 and perform designated automated inventory operations to assure that a predetermined minimum number of each beverage type (e.g., beverage items P1) are disposed at assigned display locations (e.g., display location 94L1) in accordance with user-supplied planogram data PGD. In one embodiment, planogram data PGD is entered into central controller 150 by way of a suitable update interface 190 (e.g., from an external computer terminal over a network or internet link). In one embodiment central controller 150 is configured to coordinate various product data received from various subsystems and outside sources to generate and maintain/update a product database 152. In the exemplary embodiment, central controller 150 manages product database 152 using one or more of loaded product SKU data LSPC received from product loading subsystem 110, backstock product data BPD received from backstock management subsystem 120, and restock request/delivered data RRDD from product handling subsystem 130 and/or display management subsystem 140. In one embodiment the different beverage types P1-P4 are arranged (presented for sale) in the beverage case 90 according to planogram data PGD In general, planograms are predominantly used in retail businesses and define the location and quantity of products to be placed on display, often with detailed specifications on the number of product facings and spacing; shelf layout, height, width, slant and depth and necessary or recommended chiller conditions. With respect to the present invention, planogram data PGD determines which beverage type P1 to P4 is disposed/displayed in each display location 94L1 to 94L4. For clarity and brevity, it is assumed that planogram data PGD specifies that beverage items P1 are assigned to display location 94L1, beverage items P2 are assigned to display location 94L2, beverage items P3 are assigned to display location 94L3 and beverage items P4 are assigned to display location 94L4. The rules and theories for creating planograms are set under the terms of merchandising that are not important to the present invention.

Central controller 150 optionally receives periodically updated planogram data PGD by way of planogram update interface 190. In one embodiment, central controller 150 processes and organizes this received data to generate product database 152. In one embodiment, central controller 150 utilizes the product database 152 to control backstock management subsystem 120, product handling subsystem 130 and display management subsystem 140 (e.g., by way of transmitting appropriate control signals) to automatically perform deliver (display shelf restock) operations during which backstocked beverage items are moved from backstock shelf 97 to display shelf 94 as described below.

In some embodiments, central controller 150 also utilizes product database 152 to coordinate automated ordering of resupply beverages such that display shelf 94 remains stocked with beverage items in accordance with user-defined planogram data PGD. In some embodiments, IMDS system 100 includes artificial intelligence (AI) or other forecasting model software 155 and a purchasing information technology (IT) software 159 to perform automated ordering of resupply beverages from outside product distributors/suppliers. In some embodiments, forecasting model software 155 and purchasing IT software 159 are implemented on central controller 150. In other embodiments, one or more of forecasting model software 155 and purchasing IT software 159 are implemented on external systems (i.e., maintained and operated by the store owner), and central controller 150 is configured to communicate (interface) with the external system(s). For example, a store owner may implement retail management software (e.g., Symphony Retail) that communicates with central controller 150.

FIGS. 2A, 2B and 2C respectively depict product loading subsystem 110 (shown in FIG. 1) at three sequential times (i.e., t1, t2 and t3) during an exemplary product ingestion operation. Each of FIGS. 2A to 2C depicts a relevant portion of rear wall section 91R from a perspective located outside of beverage case 90 (shown in FIG. 1).

Referring to FIG. 2A, at time t1 four product items P1 disposed in crate C1 are collectively placed by a delivery person (not shown) on an upper belt surface of conveying mechanism 111 at loading position 112-1. Note that, at time t1, product loading gate 117 is in its default closed state (i.e., such that product loading gate 117 entirely covers loading port 95R to prevent the escape of cold air from the beverage case). In one embodiment, the delivery person then enters loaded product SKU data (or other information identifying crate C1 and product items P1) by way of user interface device 119. In some embodiments product loading subsystem 110 includes a safety device (e.g., a light curtain, not shown) that is configured to verify the delivery person is positioned safely away from loading position 112-1 before actuating any mechanisms.

Referring to FIG. 2B, at subsequent time t2 the ingestion controller (shown in FIG. 1) transmits a first set of control signals to a drive motor or other actuator (not shown) that controls the opened/closed state of product loading gate 117, thereby causing the actuator to move product loading gate 117 from the closed state (shown in FIG. 1) to an opened state (e.g., product loading gate 117 is slid upward in the Z-axis direction, thereby uncovering loading port 95R). The ingestion controller (shown in FIG. 1) also transmits second control signals to a drive motor (not shown) that controls conveyor mechanism 111 such that, when product loading gate 117 is in the opened state, the drive motor causes the upper belt surface of conveyor mechanism 111 to move toward rear wall section 91R (i.e., in the direction of dashed-line arrow A1), thereby causing crate C1 and product items P1 to pass through loading port 95R into the beverage case. In one embodiment the ingestion controller terminates the second control signals conveyor mechanism 111 moves crate C1 into receiving position 112-2 (shown in FIG. 1 and FIG. 3A).

Referring to FIG. 2C, at subsequent time t3 (e.g., after crate C1 has been moved into the receiving position), the ingestion controller (shown in FIG. 1) transmits a third set of control signals to the product loading gate actuator (not shown), thereby causing product loading gate 117 to move from the opened state (shown in FIG. 2B) back into the closed state over loading port 95R.

FIGS. 3A to 3E depict an inside surface of rear wall section 91R (i.e., from a perspective inside beverage case 90, shown in FIG. 1), storage shelf 97, a portion of conveying mechanism 111 including receiving position 112-2, and a portion of backstock management subsystem 120.

Referring to FIG. 3A, storage shelf 97 includes three vertically oriented storage shelves 97-1, 97-2 and 97-3 that are mounted on and supported by a first shelf support frame 98-1. In this example, each storage shelf includes four storage locations (i.e., storage shelf 97-1 includes storage locations 97L11 to 97L14, storage shelf 97-2 includes locations storage 97L21 to 97L24 and storage shelf 97-3 includes storage locations 97L31 to 97L34). With this arrangement storage (backstock) locations 97L11 to 97L34 are arranged in a vertical plane (i.e., parallel to the Y-Z plane and rear wall 91R).

In the exemplary embodiment, the first robot mechanism of backstock management subsystem 120 is implemented by a (first) vertically oriented gantry robot mechanism 121. Gantry robot mechanism 121 generally includes a horizontal rail 122 fixedly mounted onto shelf support frame 98-1, two vertical rails 123 that are movably connected to and supported by horizontal rail 122, and an end effector 125 that is movably connected to and supported between vertical rails 123. Gantry robot mechanism 121 is configured such that end effector 125 can be positioned in front of (adjacent to) any of receiving position 112-2 and storage (backstock) locations 97L11 to 97L34 by way of a positioning mechanism formed by horizontal rail 122, one or more horizontal actuator 124H, vertical rails 123 and one or more vertical actuators 124V. That is, end effector 125 (along with vertical rails 123) can be moved horizontally (in the Y-axis direction) along horizontal rail 122 by way of horizontal actuator 124H, and end effector 125 can be moved vertically (in the Z-axis direction) along vertical rails 123 by way of vertical actuator 124V. In one embodiment, end effector 125 includes a crate support structure 126 and an extraction mechanism formed by a crate gripper 127 and a storage actuator 124S. As depicted in FIGS. 3A and 3E, crate gripper 127 and a storage actuator 124S are configured to extract (remove) a selected crate from any of receiving position 112-2 and storage (backstock) locations 97L11 to 94L-34 such that the extracted crate is disposed on and entirely supported by crate support structure 126. Crate support structure 126 is a shelf-like structure that is sized and constructed to receive and entirely support at least one extracted crate. As described below with reference to FIG. 3B, crate gripper 127 and a storage actuator 124S are also configured to insert (push) a crate from crate support structure 126 into any of storage (backstock) locations 97L11 to 94L-34. In one embodiment, actuators 124H, 124V and 124S are implemented using one or more of a piston, a motorized chain actuator, a linear motor or any other mechanism that facilitates linear actuation.

FIGS. 3A to 3D depict an exemplary series of storage operations performed by backstock management subsystem 120 according to an embodiment.

FIG. 3A shows backstock management subsystem 120 at an initial time t4 during a first storage operation. Note that time t4 occurs after an ingested crate C1 (including a batch of beverage items P1) has been positioned by conveying mechanism 111 at receiving position 112-2 and product loading gate 117 has been actuated to close loading port 95R. In addition, at time t4 gantry robot mechanism 121 has already positioned end effector 125 in front of receiving location 112-2 and crate gripper 127 has been manipulated to grasp crate C1 (i.e., after storage actuator 124S has operably moved crate gripper 127 in the direction indicated by arrow A2). Subsequent to time t4, storage actuator 124S retracts crate gripper 127 (i.e., in the direction indicated by arrow A3) such that crate C1 is pulled from receiving position 112-2 onto crate support structure 126.

FIG. 3B shows backstock management subsystem 120 at a time t5 (subsequent to time t4) after horizontal actuator 124H and vertical actuator 124V have been utilized to reposition end effector 125 (by way of horizontal rail 122 and vertical rails 123) from receiving position 112-2 to a position in front of an assigned storage location 97L11. Subsequent to time t5, storage actuator 124S pushes crate gripper 127 (i.e., in the direction indicated by arrow A4) such that crate C1 is pushed from crate support structure 126 and inserted into assigned storage location 97L11).

FIG. 3C shows backstock management subsystem 120 at a subsequent time t6 after the first storage operation has been completed (i.e., after crate C1 has been inserted into assigned storage location 97L11 on storage shelf 97-1) and end effector 125 has been repositioned in front of receiving position 112-2 to perform a second storage operation involving a second ingested crate C2 containing beverage items P2. Subsequent to time t6 backstock management subsystem 120 procures and moves second ingested crate C2 to its assigned storage location (e.g., storage location 97L12 on storage shelf 97-1).

FIG. 3D shows backstock management subsystem 120 at a subsequent time t7 after multiple storage operations have been completed (i.e., after two more crates C1 have been inserted into assigned storage locations below storage location 97L11 on storage shelves 97-2 and 97-3, two crates C2 have been inserted into assigned storage locations below storage location 97L12 on storage shelves 97-2 and 97-3, three crates C3 have been inserted into vertically aligned storage locations including storage location 97L13, and three crates C4 have been inserted into vertically aligned storage locations including storage location 97L14). At time t7 end effector 125 has been repositioned in front of receiving position 112-2 to perform a final storage operation involving the transfer of a final ingested crate C2 to assigned storage location 97L32 on storage shelf 97-3). At the completion of this final storage operation the beverage case has a maximum backstock inventory (i.e., all available storage locations have been occupied by crates C1 to C4).

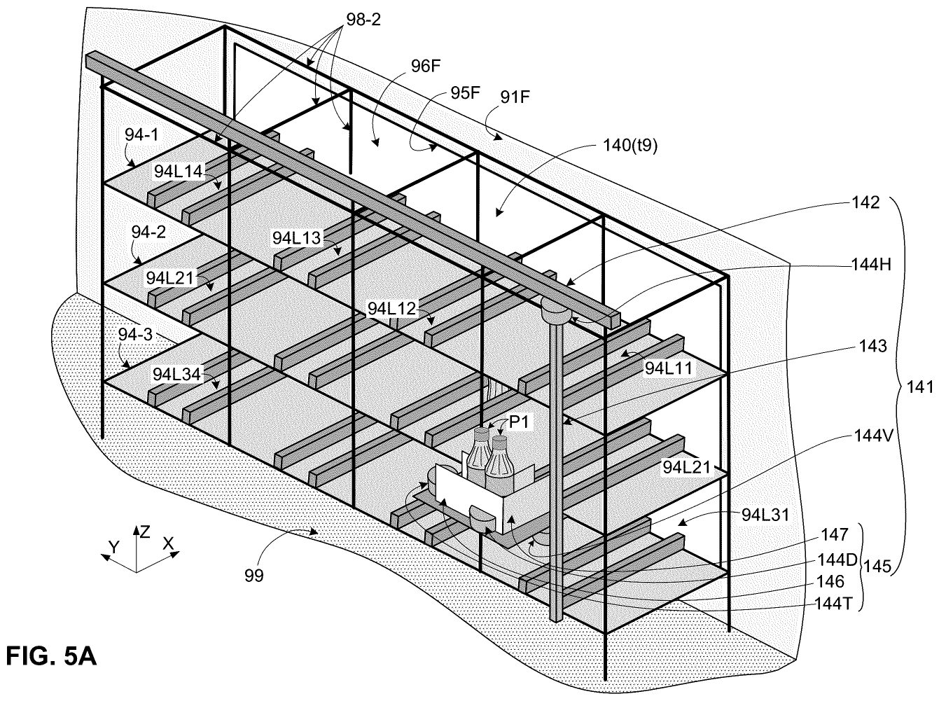

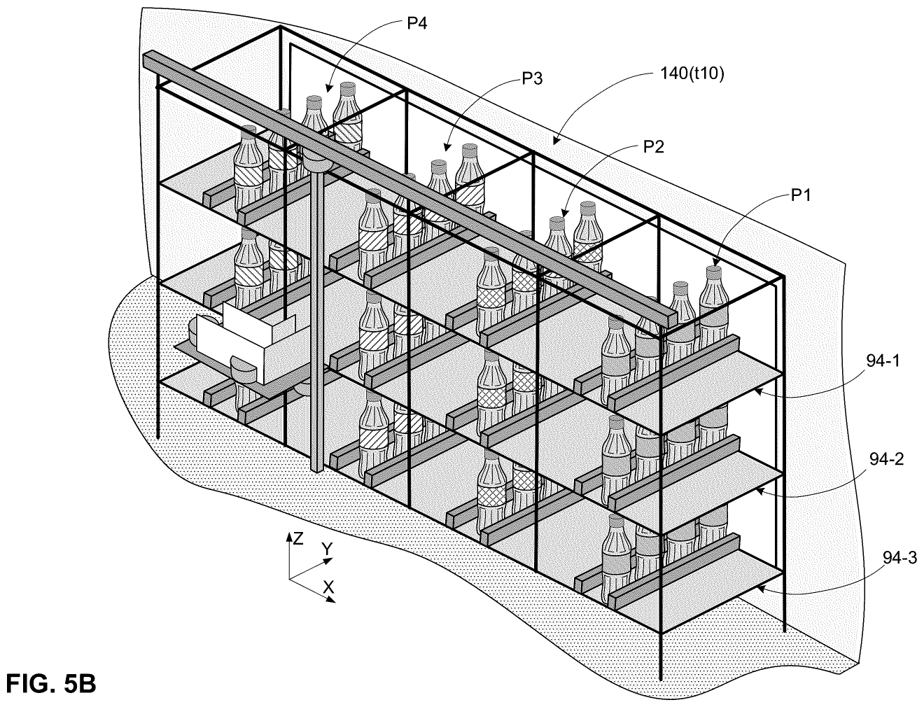

Exemplary delivery (display shelf stocking) operations are described below with reference to FIGS. 3E to 6D, where a first portion of each delivery operation is described with reference to FIGS. 3E and 4A, a second portion of each delivery operation is described with reference to FIGS. 4A and 4B, and a third portion of each delivery operation is described with reference to FIGS. 5A and 6A to 6D.

FIG. 3E shows backstock management subsystem 120 at a subsequent time t7 during an extraction operation performed at the beginning of a first delivery (display shelf stocking) operation. At this point the positioning mechanism of is controlled to position end effector 125 for the extraction of crate C1 (including a batch of beverage items P1) from storage location 97L11. The extraction operation involves utilizing the extraction mechanism of gantry robot mechanism 121 (i.e., actuator 124S and gripper 127) to pull crate C1 (i.e., in the direction of arrow A5) from storage location 97L11 onto support structure 127.

FIGS. 4A and 4B depict a product transfer operation performed by product handling subsystem 130 according to an embodiment. Product handling subsystem 130 includes an articulated robot 131 (second robot system) that is disposed between first transfer location TL1 and second transfer location TL2 and is configured (by way of an arm mechanism 133 and an appropriate end effector 135) to sequentially remove product items P1 from crates C1 and move the removed product items P1 to second transfer location TL2. FIG. 4A shows portion of backstock management subsystem 120 and product handling subsystem 130 at a subsequent time t81 after the positioning mechanism of gantry robot mechanism 121 has positioned end effector 125 in first transfer location TL1, and after arm 133 of articulated robot 131 has manipulated end effector 135 to extract (remove) a beverage item P1 from crate C1 (as indicated by dashed-line arrow A61). FIG. 4B shows product handling subsystem 130 and a portion of display management subsystem 140 at a subsequent time t82 after a positioning mechanism of the second robot system of display management subsystem 140 has positioned an end effector 145 in second transfer location TL2, and dashed-line arrow A62 indicates how arm 133 of articulated robot 131 is subsequently manipulates effector 135 to place extracted beverage item P1 into end effector 145 (while end effector 145 is maintained at second transfer location TL2). By repeating the transfer operation depicted in FIGS. 4A and 4B, articulated robot 131 is able to transfer the entire batch of beverage items P1 from crate C1 at first transfer location TL1 to end effector 145 and second transfer location TL2. In some embodiments (not shown), the end effector of articulated robot 131 is configured to simultaneously carry two or more extracted beverage items between transfer locations TL1 and TL2. In one embodiment, articulated robot 131 is a 4-axis robot.

FIGS. 5A and 5B depict an inside surface of front wall section 91F (including front opening 95F and access doors 96F), display shelf 94 and a portion of display management subsystem 140.

Referring to FIG. 5A, display shelf 94 includes three vertically oriented display shelves 94-1, 94-2 and 94-3 that are mounted on and supported by a second shelf support frame 98-2. In this example, each display shelf includes four chute-type display locations (i.e., display shelf 94-1 includes display locations 94L11 to 94L14, display shelf 94-2 includes locations display 94L21 to 94L24 and display shelf 94-3 includes display locations 94L31 to 94L34). With this arrangement display locations 94L11 to 94L34 are arranged in a vertical plane (i.e., parallel to the Y-Z plane and front wall 91F).

In the exemplary embodiment, the third robot mechanism of display management subsystem 130 is implemented by a (second) vertically oriented gantry robot mechanism 141. Gantry robot mechanism 141 generally includes a horizontal rail 142 fixedly mounted onto shelf support frame 98-2, a vertical rail 143 that is movably connected to and supported by horizontal rail 142, and an end effector 145 that is movably connected to and supported by vertical rail 143. Gantry robot mechanism 141 is configured such that end effector 145 can be positioned in front of (adjacent to) any of second transfer location TL2 and display locations 94L11 to 94L34 by way of a positioning mechanism formed by horizontal rail 142, one or more horizontal actuator 144H, vertical rail 143 and one or more vertical actuators 144V. That is, end effector 145 (along with vertical rail 143) can be moved horizontally (in the Y-axis direction) along horizontal rail 142 by way of horizontal actuator 144H, and end effector 145 can be moved vertically (in the Z-axis direction) along vertical rail 143 by way of vertical actuator 144V. In one embodiment, end effector 145 includes a beverage item delivery mechanism formed by a transfer channel 146 configured to receive beverage items P1 from product handling subsystem 130 (as described above with reference to FIG. 4B), a delivery channel 147 configured to sequentially feed beverage items P1 from transfer channel 146 into the back end of a designated display location 94L21, and one or more actuators 144D and 144T that are configured to bias beverage items P1 along transfer channel 146 toward delivery channel 147, and to sequentially push beverage items P1 from delivery channel 147 onto designated display location 94L21.

FIGS. 6A to 6D depict the delivery of a batch of beverage items P1 by end effector 145 onto designated display location 94L21 according to an embodiment. As indicated in FIG. 6A, display shelf location 94L21 has a chute-type configuration having a front end 94L21F adjacent access door 96F and an opposing back end 94L21B that is open (grooved) to facilitate the delivery of beverage items P1. In this example, end effector 145 is moved by way of the second positioning mechanism to point behind display location 94L21 (e.g., such that delivery channel 146 is aligned with back end 94L21B of display location 94L21. In this position, transfer channel 146 is aligned perpendicular to chute-type display location 94L21, and transfer actuator 144T (shown in FIG. 5A) biases beverage items P1 toward delivery channel 146 (i.e., in the negative-Y-axis direction indicated in FIG. 5A). As indicated in FIG. 6B, delivery actuator 144D applies a pushing force to a first beverage item P1(1) (indicated by dashed-line arrow A71), whereby beverage item P1(1) is pushed along delivery channel 146 and through back end 94L21B onto display location 94L21. The ejection of beverage item P1(1) allows a next-sequential beverage item P1(2) to enter delivery channel 146. As indicated in FIG. 6C by dashed-line arrow A8, chute-type display location 94L21 is inclined such that beverage item P1(1) slides (due to gravity) toward front end 94L21F and is then stopped by a bumper/barrier (not shown) such that it is positioned for viewing through access door 96F. At approximately the same time, delivery actuator 144D pushed beverage item P1(2) into display location 94L21 (indicated by dashed-line arrow A72) in the manner described above. As indicated in FIG. 6D, the delivery ejection of beverage items P1 then continues until the entire batch of beverage items P1 has been delivered to display location P4L21. At this point, end effector 145 is empty and may be conveyed back to second transfer location TL2 to receive a next sequential batch of beverage items.

FIG. 5B shows display management subsystem 140 at a time t10 after beverage items P1 to P4 have been delivered from storage shelves 97-1 to 97-3 (shown in FIG. 3E) to display shelves 94-1 to 94-3, for example, in accordance with user-supplied planogram data.

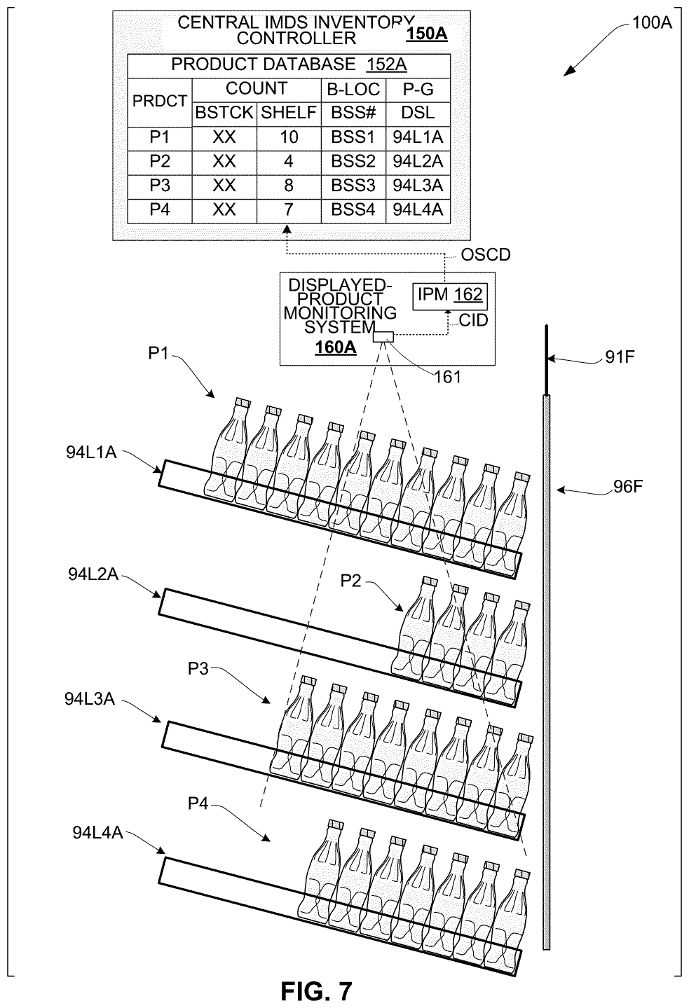

FIG. 7 shows a portion of a IMDS system 100A according to an embodiment in which IMDS system 100A further includes a displayed-product monitoring system 160A, which is utilized to monitor the number of beverage items P1 to P4 respectively disposed on display shelves 94L1A to 94L4A and to report any reductions in the number of displayed beverage items to central controller 150A. Note that display shelves 94L1A to 94L4A are arranged in a vertical direction for purposes of describing displayed-product monitoring system 160A, and that displayed-product monitoring system 160A may be modified using known techniques to monitor any display shelf configuration. Other than the specific features described below with reference to FIG. 7, IMDS 100A is understood to include a beverage case (climate-controlled environment) that includes a product loading subsystem, a backstock management subsystem, a product handling subsystem and a display management subsystem that are configured and operate as described above with reference to FIGS. 1 to 6E.

Displayed-product monitoring system 160A is at least partially disposed inside the beverage case 90 (e.g., adjacent front wall section 91F and access doors 96F) and is configured to detect the incremental removal of beverage items P1 to P4 from display shelf locations 94L1A to 94L4A, respectively. In one embodiment monitoring system 160A generally includes at least one camera 161 and an image processing module (IPM) 162. In one embodiment camera 161 is a commercially available digital video camera that is operably mounted and otherwise configured to capture current image data CID from display shelves 94L1A to 94L4A and to transmit the current image data CID to the image processing module 162. In one embodiment the image processing module 162 is a stand-alone electronic device that is configured using hardware and/or software techniques (e.g., known image processing techniques such as background subtraction, object segmentation, and identification) to identify the incremental removal of beverages from the display shelves 94L1A to 94L4A by comparing the current image data CID with stored image data that reflects the number of beverages on display shelves 94L1A to 94L4A at a prior time. That is, the stored image data operably visually describes the number of each beverage type on their assigned display shelves 94L1A to 94L4A at a selected time, and the current image data CID operably visually describes the number of each beverage type on their assigned display shelves at a current time (i.e., after the selected time). The image processing module 162 identifies the incremental removal of beverages from the display shelves 94L1A to 94L4A by identifying relevant differences between the current image data CID and the stored image data, where the relevant differences arise from the removal of one or more beverage items from the beverage case (e.g., by a customer). When the removal of one or more beverage items from the beverage case is detected, image processing module 162 generates and transmits corresponding on-shelf count data OSCD to central controller 150A, which then uses the data to update the appropriate on-shelf count value in product database 152A to reflect the reduced number of displayed beverage items. Automatically monitoring the removal of beverage items from the beverage case in this manner reduces personnel and operating costs by relieving store personnel from the task of perform manual inspection of displayed inventory.

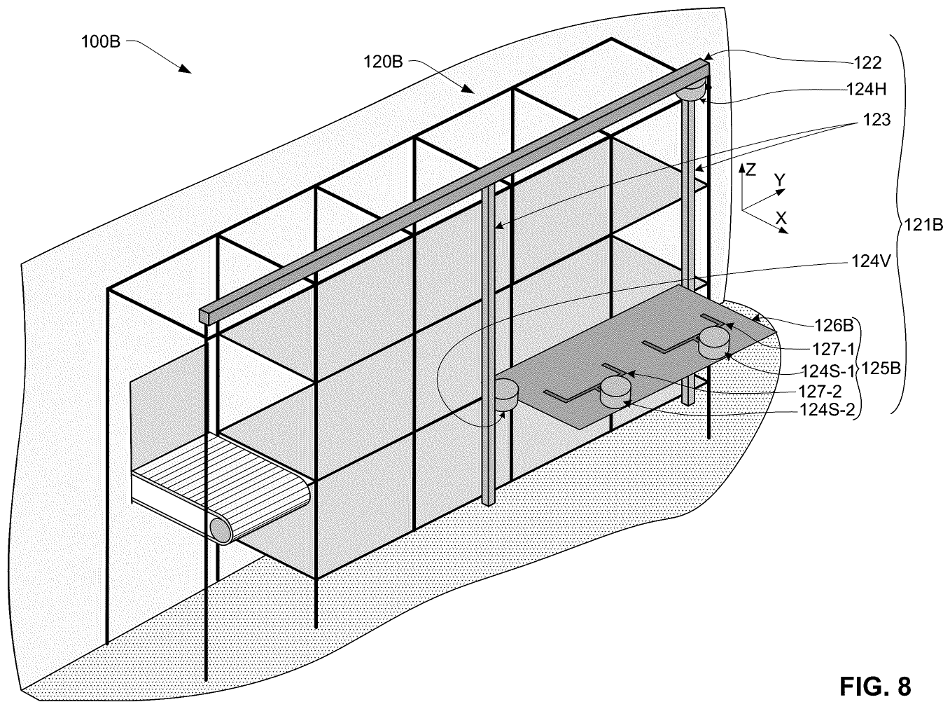

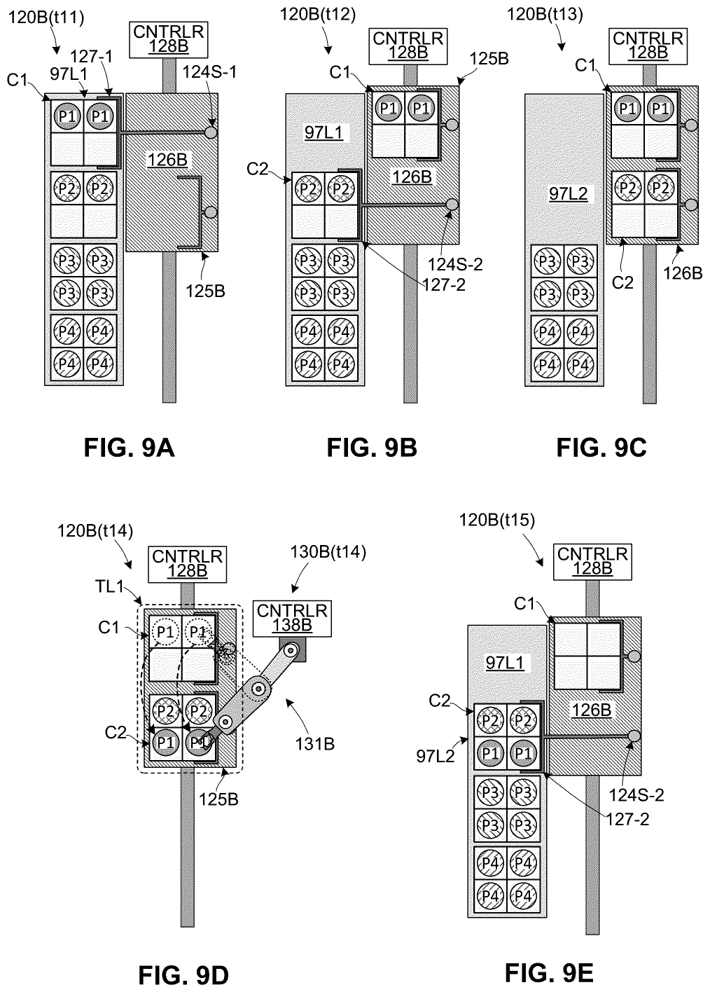

FIG. 8 shows a partial IMDS system 100B including a backstock management subsystem 120B according to an alternative embodiment. As in the previous embodiment, backstock management subsystem 120B includes a gantry robot mechanism 121B having a positioning mechanism formed by horizontal rail 122, two vertical rails 123, horizontal actuator 124H and vertical actuator 124V, all of which function and operate as described above to position end effector 125B in front of any storage location. In this embodiment, end effector 125B includes two side-by-side extraction mechanisms, where a first extraction mechanism is formed by a first crate gripper 127-1 that is actuated (operated) by way of a first storage actuator 124S-1, and a second extraction mechanism is formed by a second crate gripper 127-2 that is actuated (operated) by way of a second storage actuator 124S-2. End effector 125B also includes a crate support platform 126B that is constructed and operates in a manner similar to that described above but differs from the earlier described embodiment in that it is modified to simultaneously accommodate two crates (as described below with reference to FIGS. 9A to 9E).

FIGS. 9A to 9E depict operations performed by backstock management subsystem 120B that illustrate the advantages of modified end effector 125B. FIG. 9A shows backstock management subsystem 120B at a time t11 during which controller 128B operably positions end effector 125B and controls the first extraction mechanism (i.e., gripper 127-1 and actuator 124S-1) to access and operably grasp crate C1, which is stored in storage location 97L1. Note that crate C1 includes two beverage items P1, and that two storage sections of crate C1 are empty. FIG. 9B shows backstock management subsystem 120B at a time t12 after controller 128B controls the first extraction mechanism to pull crate C1 from storage location 97L1 onto a first portion of support structure 126B and has repositioned end effector 125B and controlled the second extraction mechanism (i.e., gripper 127-2 and actuator 124S-2) to access and operably grasp crate C2, which is stored in storage location 97L2. Note that crate C2 includes two beverage items P2, and that two storage sections of crate C1 are empty. FIG. 9C shows backstock management subsystem 120B at a time t13 after controller 128B controls the second extraction mechanism to pull crate C2 from storage location 97L2 onto a second portion of support structure 126B. FIG. 9D shows backstock management subsystem 120B and a portion of a product handling system 130B at a time t13, where product handling system 130B forms a part of IMDS system 100B and operations substantially as described above with reference to IMDS system 100. As depicted in FIG. 9D, an advantage provided by modified end effector 125B is that, when controller 128B causes the positioning mechanism to position end effector 125B at first transfer location TL1, product handling subsystem 130B can be utilized to perform a consolidating function, for example, by moving the two beverage items P1 from crate C1 into the empty storage sections of crate C2. Subsequently, at time t15 indicated in FIG. 9E, controller 128B controls the second extraction mechanism to push crate C2 from support structure 126B back into storage location 97L2. Note that the backstock inventory is also updated to reflect the new location of backstocked beverage items P1 in storage location 97L2, and that storage location 97L1 is now available to receive a full crate. In one embodiment, empty crate C1 is passed out of the beverage case, for example, by way of the product loading subsystem.

FIG. 10 illustrates how an IMDS system 100C of the present invention may be modified to accommodate a nonlinear display shelf arrangement. As in previous embodiments, IMDS system 100C includes a product loading subsystem 110C, a backstock management subsystem including a first gantry robot mechanism 121C, a product handling subsystem implemented by an articulated robot mechanism 131C, and a display management subsystem including a second gantry robot mechanism 141C, all of which being disposed inside a beverage case (e.g., the area indicated by floor region 99C1). Product loading subsystem 110C and articulated robot mechanism 131C are constructed and operate as described above with reference to IMDS system 100 (FIGS. 1-4B). First gantry robot mechanism 121C includes a linear horizontal rail 122C that facilitates positioning a first end effector 125C adjacent any of the multiple storage locations provided by display shelving 97C and is otherwise constructed and operates as described above with reference to FIGS. 8 and 9A-9E. Second gantry robot mechanism 141C similarly includes a second end effector 145C that is supported on a single vertical rail 142C suspended from a horizontal rail 142C, whereby gantry robot mechanism 141C operates in a manner similar to that described above with reference to FIGS. 1, 5 and 6A-6D.

For various reasons some beverage cases are configured with nonlinear display shelf arrangements, such as that depicted in FIG. 10. In this case, three offset display shelf banks 94C-1, 94C-2 and 94C-3 are arranged such that a first set of display locations 94L-1C provided by (disposed on) display shelf bank 94C-1 are arranged in a vertical plane P1 (i.e., in the X-Z plane of the depicted coordinate reference), a second set of display locations 94L-2C disposed on display shelf bank 94C-2 are arranged in a vertical plane P2 that intersects the X-Z plane at an acute angle 81, and a third set of display locations 94L-3C disposed on display shelf bank 94C-3 are arranged in a vertical plane P3 that intersects the X-Z plane at an obtuse angle 82, where both angles 81 and 82 are not parallel to the X-Z plane. With this arrangement, a customer standing in sales floor section 99C2 is able to easily view beverage items presented for display in any of display shelf banks 94C-1 to 94C-3.

IMDS system 100C (FIG. 10) illustrates an advantage provided by the delivery mechanism configuration utilized by second gantry robot mechanism 141C. Specifically, gantry robot mechanism 141C can be easily modified/adapted to accommodate nonparallel display shelf configurations (such as that shown in FIG. 10) by way of modifying horizontal rail 142C such that it extends between display shelf banks 94C-1 to 94C-3 (i.e., such that end effector 145C is able to access the back end of any of the display locations disposed on all three of display shelf banks 94C-1 to 94C-3). In the example depicted in FIG. 10, horizontal rail 142C is modified to include three linear sections connected by two curved sections, where a first linear section 143C-1 is fixedly connected to display shelf bank 94C-1 and extends in a direction parallel to vertical plane P1, a second linear section 143C-2 is fixedly connected to display shelf bank 94C-2 and extends in a direction parallel to plane P2, a third linear section 143C-3 is fixedly connected to display shelf bank 94C-3 and extends in a direction parallel to plane P3, a first curved section 142C-12 links linear sections 142C-1 and 142C-2, and a second curved section 142C-13 links linear sections 142C-1 and 142C-3. With this arrangement, second gantry robot mechanism 141C is able to receive a batch of beverage items (not shown) by way of a transfer operation (i.e., from first gantry robot mechanism 121C by way of articulated robot mechanism 131C in the manner described above), where the transfer operation is performed while end effector 145C is positioned at a designated transfer location TL2 (e.g., behind display shelf bank 94C-2). Once the transfer operation is completed, second gantry robot mechanism 141C is able to deliver the received batch of beverage items (i.e., by way of moving end effector 145 along horizontal rail 142C to any display location provided by any of display shelf banks 94C-1 to 94C-3).

Although the present invention has been described with respect to certain specific embodiments, it will be clear to those skilled in the art that the inventive features of the present invention are applicable to other embodiments as well, all of which are intended to fall within the scope of the present invention. For example, although the present invention is described above with specific reference to the management of cold drinks (e.g., canned/bottled beverage items) that are sold from a beverage case located, for example, in a convenience store, where customers access and manually remove selected beverage items by way of opening/closing glass access doors (e.g., doors 96F, FIG. 1), the IMDS system may be beneficially utilized in other settings while remaining within the spirit and scope of the invention. For example, the IMDS system may be utilized to manage hot or cold food/beverage items offered for sale in a vending-machine-type arrangement (i.e., wherein a selected product item is automatically dispensed by way of a gravity-fed hopper or other exit port). Note that the removal of selected product items from display shelves in such vending-machine-type arrangements is performed automatically using known techniques, whereby the reductions in the number of each product item type may be determined by actuation of the automatic dispensing mechanism, thereby obviating the need for a vision-based or sensor-based displayed-product monitoring arrangement.

1. An automated system for automatically managing product items in a climate-controlled enclosure according to planogram data, the climate-controlled enclosure having a peripheral wall surrounding a climate-controlled environment containing a plurality of display shelf locations arranged along a first wall section of the peripheral wall and a plurality of storage locations arranged along a second wall section of the peripheral wall, the system comprising:
a backstock management subsystem including a first robotic system configured to perform a plurality of storage operations, wherein each storage operation involves moving a crate from a receiving location ea into an associated storage location of the plurality of storage locations, wherein each crate contains an associated batch of said product items, said first robotic system also being configured to perform a first portion of a plurality of delivery operations, each first portion including removing a selected crate from its associated storage location and moving said selected crate to a first transfer location;
a product handling subsystem perform a second portion of said plurality of delivery operations, each second portion including a second robotic system configured to perform a second portion of said plurality of delivery operations, each second portion including sequentially transfer transferring at least some of the product items of the associated batch of product items from the selected crate to a second transfer location while said selected crate is maintained in the first transfer location by the first robotic system;
a display management subsystem including a third robot system configured to perform a third portion of said plurality of delivery operations, each third portion including moving the product items from the second transfer location to one of the plurality of display shelf locations; and
an inventory control subsystem configured to coordinate operations performed by the backstock management subsystem, the product handling subsystem and the display management subsystem such that the product items are moved onto a designated shelf location specified by the planogram data during each said delivery operation.

2. The system of claim 1,
wherein the system further comprises a product loading subsystem configured to perform a plurality of ingestion operations such that said product loading subsystem automatically conveys an ingested crate from a loading position located outside the climate-controlled environment to the receiving position during each said ingestion operation.

3. The system of claim 2,
wherein the peripheral wall of the climate-controlled enclosure defines a loading port, and
wherein the product loading subsystem comprises:
a conveying mechanism extending through the loading port;
an insulated product loading gate disposed adjacent to the loading port and movable between a closed state in which the product loading gate entirely covers the loading port, and an opened state in which the product loading gate is positioned away from the loading port; and
an ingestion controller configured to coordinate operations of the conveying mechanism and the product loading gate during each said ingestion operation such that, when said ingested crate is placed on conveying mechanism in the loading position, the product loading gate is actuated to move from the closed state to the opened state, the conveying mechanism is actuated to convey said ingested crate through the loading port to the receiving position, and then the product loading gate is actuated to move from the opened state to the closed state.

4. The system of claim 2, wherein the product loading subsystem comprises an interface device configured to receive product data identifying product items placed on conveying mechanism during each said ingestion operation.

5. The system of claim 1,
wherein the plurality of storage locations are arranged in a vertical plane along the second wall of the climate-controlled enclosure, and
wherein the first robotic system comprises a vertically oriented first gantry robot mechanism including a first end effector and a first positioning mechanism operably configured to move the first end effector from the receiving location to the associated storage location during each said storage operation, and to move the first end effector to the first transfer location during the first portion of each said delivery operation.

6. The system of claim 5,
wherein the climate-controlled enclosure includes a storage shelf mounted on a first shelf support frame, and
wherein the first gantry robot mechanism further comprises a horizontal rail fixedly mounted onto the first shelf support frame.

7. The system of claim 5,
wherein the first end effector further comprises at least one extraction mechanism and a support structure, the extraction mechanism being configured to extract the selected crate from the first storage location, and the support structure being configured to receive and entirely support the extracted selected crate when the first gantry robot mechanism moves the first end effector to the first transfer location.

8. The system of claim 7, wherein the product handling subsystem comprises an articulated robot disposed between the first transfer location and the second transfer location and being configured to sequentially remove the product items from the selected crate and move said removed product items to the second transfer location.

9. The system of claim 8, wherein the first end effector further comprises a first extraction mechanism, a second extraction mechanism and a support structure, the first extraction mechanism being configured to extract the selected crate from the first storage location onto a first portion of the support structure, the second extraction mechanism being configured to extract a second crate from a second storage location onto a second portion of the support structure.

10. The system of claim 9, wherein the articulated robot is further configured to move product items from the selected crate to the second crate when the first end effector is located in the first transfer location.

11. The system of claim 1,
wherein the plurality of display shelf locations are arranged in at least one vertical plane along the first wall of the climate-controlled enclosure, and
wherein the third robotic system comprises a vertically oriented second gantry robot mechanism including a second end effector and a second positioning mechanism operably configured to position the second end effector adjacent to any of said plurality of display shelf locations.

12. The system of claim 11,
wherein the climate-controlled enclosure includes a display shelf mounted on a second shelf support frame, the display shelf including the plurality of display shelf locations, and
wherein the second gantry robot mechanism further comprises a horizontal rail fixedly mounted onto the second shelf support frame.

13. The system of claim 11,
wherein each of the plurality of display shelf locations comprises a chute-type configuration having a front end and a back end, and
wherein the second end effector includes a delivery mechanism having a transfer channel configured to receive the product items transferred to the second transfer location, a delivery channel configured to sequentially feed the product items from the transfer channel into the back end of the designated shelf location, and one or more actuators configured to bias the product items along the transfer channel and the delivery channel.

14. The system of claim 11,
wherein the plurality of display locations are disposed on first and second offset display shelf banks arranged such that a first set of said display locations disposed on the first offset display shelf bank are arranged in a first vertical plane and a second set of said display locations disposed on the second offset display shelf bank are arranged in a second vertical plane that intersects the first vertical plane at a non-parallel angle,
wherein the second gantry robot mechanism further comprises a nonlinear horizontal rail including a first section fixedly connected to the first offset display shelf bank and extending parallel to the first vertical plane, and a second section fixedly connected to the second offset display shelf bank and extending parallel to the second vertical plane, and
wherein the second positioning mechanism is operably configured to move the second end effector between any of said plurality of display locations disposed on first and second offset display shelf banks.

15. The system of claim 1, further comprising a displayed-product monitoring system configured to detect an incremental removal of said product items from the plurality of display locations.

16. An automated system for automatically moving a batch of product items from a first storage location to a first display location within a climate-controlled enclosure, the climate-controlled enclosure having a peripheral wall surrounding a climate-controlled environment containing a plurality of display shelf locations including the first display location arranged along a first wall section of the peripheral wall and a plurality of storage locations including the first storage location arranged along a second wall section of the peripheral wall, the system comprising:
a first gantry robot mechanism including a first end effector and a first positioning mechanism operably configured to position the first end effector adjacent to any of said plurality of storage locations, wherein the first end effector includes an extraction mechanism configured to remove the batch of product items from the first storage location such that the batch of product items is entirely supported on a support structure of the first end effector, the first positioning mechanism being further operably configured to move the first end effector to a first transfer location;
an articulated robot mechanism operably configured to sequentially move the batch of product items from the first transfer location to a second transfer location; and
a second gantry robot mechanism operably configured to move the batch of product items from the second transfer location to a location adjacent to the first display location, and to sequentially move the product items onto the first display location.

17. A method for automatically moving a batch of product items from a first storage location to a first display location within a climate-controlled enclosure, the method comprising:
utilizing a first gantry robot mechanism to move the batch of product items from the first storage location to a first transfer location;
utilizing an articulated robot mechanism to sequentially move the batch of product items from the first transfer location to a second transfer location; and
utilizing a second gantry robot mechanism to move the batch of product items from the second transfer location to a location adjacent to the first display location, and to sequentially move the product items onto the first display location.

18. The method of claim 17,
wherein the batch of product items are mounted on a crate that is removably disposed in the first storage location,
wherein the first storage location is one of a plurality of storage locations arranged along a first wall of the climate-controlled enclosure,
wherein the first gantry robot mechanism includes a first end effector and a first positioning mechanism operably configured to move the first end effector from the first storage location to the first transfer location, and
wherein utilizing the first gantry robot mechanism comprises utilizing the first positioning mechanism to position the first end effector adjacent to the first storage location, utilizing a first extraction mechanism of the first end effector to remove the crate from the first storage location such that the crate is entirely supported on a support structure of the first end effector, and then utilizing the first positioning mechanism to move the first end effector to the first transfer location.

19. The method of claim 18,
wherein the first display location is one of a plurality of display locations arranged along a second wall of the climate-controlled enclosure,
wherein the second gantry robot mechanism includes a second end effector and a second positioning mechanism operably configured to move the second end effector between the second transfer location and any of said plurality of display locations, and
wherein utilizing the articulated robot mechanism to sequentially move the product item to the second transfer location comprises utilizing the articulated robot mechanism to sequentially extract each said product item from the crate and place said extracted product item onto the second end effector while said second end effector is positioned in the second transfer location by the second positioning mechanism.

20. The method of claim 19,
wherein the first display shelf location comprises a chute-type configuration having a front end and a back end, and
wherein utilizing the second gantry robot mechanism to sequentially move the product items onto the first display location comprises utilizing the second positioning mechanism to move the second end effector from the second transfer location to a location adjacent to the back end of the first display location, and utilizing a delivery mechanism of the second end effector to sequentially push the product item onto the back end of the first display shelf location.
